(19) United States
(12) Patent Application Publication
(10) Pub. No.: US 2015/0027284 A1
(43) Pub. Date: Jan. 29, 2015

(54) STRIPPING DEVICE AND STRIPPING METHOD FOR USE WITH A FLEXIBLE SUBSTRATE

(71) Applicant: EverDisplay Optronics (Shanghai) Limited, Shanghai (CN)

(72) Inventors: Kungyu CHENG, Shanghai (CN); Tianwang HUANG, Shanghai (CN)

(21) Appl. No.: 14/340,064

(22) Filed: Jul. 24, 2014

(30) Foreign Application Priority Data
Jul. 24, 2013 (CN) 201310313770.7

(51) Int. Cl. B26D 3/28; B26D 1/547; B26D 7/00; B26D 7/18

(52) U.S. Cl. CPC B26D 3/28; B26D 7/1863; B26D 1/547; B26D 7/0006
USPC 83/23; 83/156

(57) ABSTRACT

A stripping device is provided which comprises: a wire cutter comprising a moving part and a cutting part connected to the moving part in such a manner that the moving part is able to drive the cutting part linearly; and an attracting wheel comprising a body part adapted to be movably mounted on the flexible substrate so that the body part is able to roll on the flexible substrate and an adsorption part connected to the body part to generate adsorption force to securely attach a part of the flexible substrate as the result of movement of the cutting part.

### CROSS-REFERENCE TO RELATED APPLICATIONS

This application claims benefits of Chinese Patent Application No. 201310313770.7, filed on Jul. 24, 2013 in the State Intellectual Property Office of China, the disclosure of which is incorporated herein by reference in its entirety.

### TECHNICAL FIELD

The present disclosure relates in general to a stripping device and a stripping method and, in particular, to a stripping device and stripping method for stripping a flexible substrate from a layer to which the flexible substrate is adhered.

### BACKGROUND ART

Generally, a flexible substrate 1 is adhered to a glass substrate 2 via a release layer 3. As shown in FIG. 1, in the conventional technology, a laser lift-off method is used to strip the flexible substrate from the glass substrate. The method is, as shown in FIG. 2, using a laser L to scan the release layer with release material between the flexible substrate 1 and the glass substrate 2 after TFT and OLED processes and a packaging process performed on the flexible substrate 1 are finished, so as to provide high energy to break the chemical bond between the release layer 3 and the flexible substrate 1, and destroy the adhesive connection between the flexible substrate 1 and the release layer 3, such that the flexible substrate 1 can be stripped off.

The stripping process is time-consuming since it needs laser scanning Apart from this, the laser stripping equipment cost as well as the maintenance cost is high.

As a result, it is necessary to improve the conventional stripping method and stripping device to increase the stripping efficiency and reduce the equipment cost.

The above information disclosed in this Background section is only for enhancement of understanding of the background of the disclosure and therefore it may contain information that does not form the prior art that is already known in this country to a person of ordinary skill in the art.

### SUMMARY OF INVENTION

The disclosure discloses a stripping device and a stripping method for increasing stripping efficiency and reducing equipment cost.

Additional aspects and advantages will be set forth in part in the description which follows and, in part, will be apparent from the description, or may be learned by practice of the disclosure.

According to one aspect of the disclosure, a stripping device is provided for stripping a flexible substrate from a release layer, the stripping device comprises a wire cutter comprising a moving part and a cutting part connected to the moving part in such a manner that the moving part is able to drive the cutting part linearly; and an attracting wheel comprising a body part adapted to be movably mounted on the flexible substrate so that the body part is able to roll on the flexible substrate and an adsorption part connected to the body part to generate adsorption force to securely attach a part of the flexible substrate as the result of movement of the cutting part.

In another aspect, the stripping device further comprises at least one sliding rail adapted to be formed on a side of the flexible substrate to partially accommodate the moving part so that the moving part is able to move horizontally on the at least one sliding rail.

In another aspect, the moving part is a roller.

In another aspect, the at least one sliding rail is supported by a pair of adjustable rod for adjusting height of the at least one sliding rail.

In another aspect, the height of the at least one sliding rail is adjusted by the adjustable rod to allow the cutting part to readily separate the flexible substrate from the release layer.

In another aspect, the adsorption part comprises openings communicated with the body part.

In another aspect, the stripping device further comprises a plurality of vacuum pipes and a vacuum pump, the vacuum pipes are disposed at an inside part of the body part, and an end of each vacuum pipe communicates with a shaft of the body part, and the other end communicates with the opening correspondingly, the vacuum pump is connected to the shaft so as to vacuumize the inside part of the body part to allow the adsorption part to generate adsorption force.

In another aspect, the body part has a tubular shape with outer diameter larger than or equal to length of the flexible substrate.

In another aspect, moving speed of the body part is less than or equal to moving speed of the moving part.

According to another aspect of the disclosure, a stripping method for stripping a flexible substrate from a release layer is disclosed, the method comprising the steps of:

aligning a cutting part with a stripping start line between a flexible substrate and a release layer, and disposing an attracting wheel on the flexible substrate;

moving the cutting part along a cutting direction from the stripping start line so as to cut out a part of the flexible substrate from the release layer; and

generating an adsorption force to a part of the flexible substrate through an adsorption part of the attracting wheel, and rolling a body part of the attracting wheel on the flexible substrate so as to securely attach a part of the flexible substrate as the result of movement of the cutting part.

In another aspect, moving speed of the body part is less than or equal to moving speed of the moving part.

In another aspect, when the attracting wheel moves to a cutting end point along the cutting direction, the flexible substrate is entirely wrapped on a periphery of the body part and is completely stripped from the release layer.

In another aspect, a vacuum pump is used to vacuumize an inside part of the body part to allow the adsorption part to generate the adsorption force.

In another aspect, the tripping method further comprises a step of deflating the vacuum pump to disengage the stripped flexible substrate from the attracting wheel after the flexible substrate is completely stripped from the release layer.

### BRIEF DESCRIPTION OF THE DRAWINGS

The foregoing and other features and advantages of the disclosure will be apparent to those skilled in the art in view of the following detailed description, taken in conjunction with the accompanying drawings.

FIG. 1 illustrates a schematic diagram of a flexible display panel.

FIG. 2 illustrates a flexible substrate stripped in the conventional method.

FIG. 3 illustrates a top view schematic diagram of the stripping device according to an embodiment of the disclosure.

FIG. 4 illustrates a schematic diagram of the stripping device according to an embodiment of the disclosure in a stripping state, in which a cutting process is not performed.

FIG. 5 illustrates a schematic diagram of the stripping device according to an embodiment of the disclosure in a stripping state, in which the cutting process is being performed.

FIG. 6 illustrates a schematic diagram of the stripping device according to an embodiment of the disclosure in a stripping state, in which the stripping process is finished.

FIG. 7 illustrates a schematic diagram of stripping a multi-layer substrate with the stripping device in an embodiment of the disclosure.

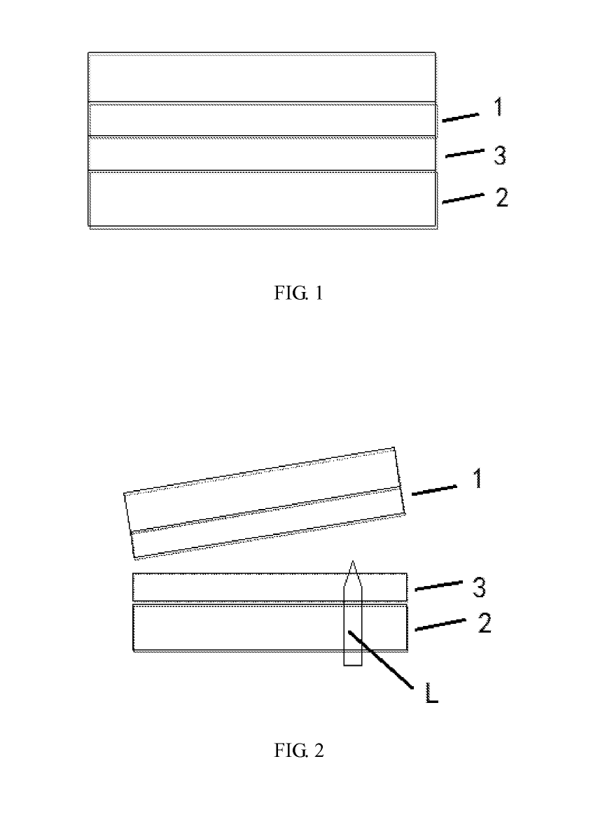

### DETAILED DESCRIPTION

Exemplary embodiments of the disclosure will now be described more fully with reference to the accompanying drawings, in which exemplary embodiments are shown. Exemplary embodiments of the disclosure may, however, be embodied in many different forms and should not be construed as being limited to the embodiments set forth herein; rather, these embodiments are provided so that this disclosure will be thorough and complete, and will fully convey the concept of exemplary embodiments to those skilled in the art. In the drawings, the thicknesses of layers and regions are exaggerated for clarity. Like reference numerals in the drawings denote like elements, and thus their description will be omitted.

The described features, structures, or/and characteristics of the disclosure may be combined in any suitable manner in one or more embodiments. In the following description, numerous specific details are disclosed to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

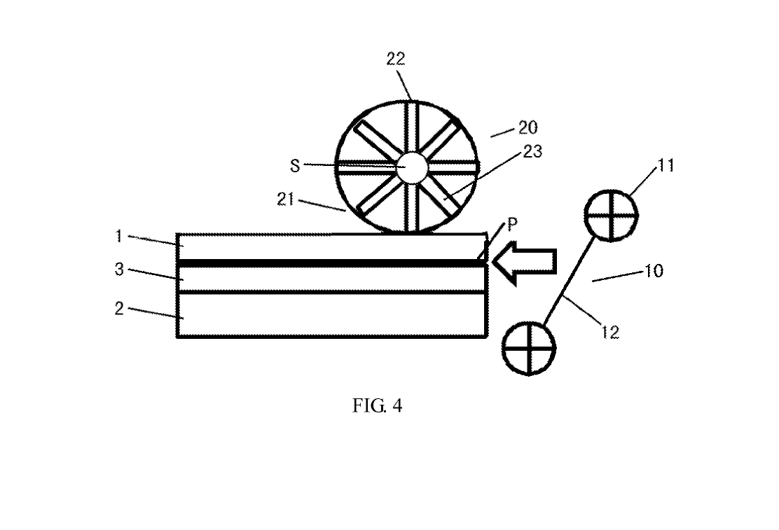

The disclosure discloses a stripping device for stripping a flexible substrate 1 from a release layer 3. As shown in FIG. 4, the device includes a wire cutter 10 and an attracting wheel 20.

The wire cutter 10 includes a moving part 11 and a cutting part 12. The moving part 11 is connected to the cutting part 12 for driving the cutting part 12 to move linearly.

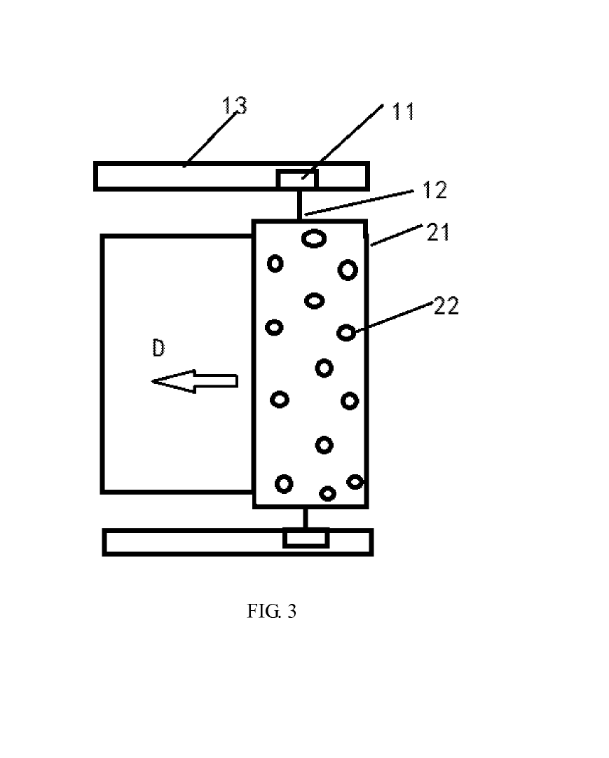

In the embodiment, as shown in FIG. 3, a pair of sliding rails 13 are disposed at two sides of the flexible substrate 1, and the sliding rails 13 have a length which at least allows the sliding rails 13 to extend from an end of the flexible substrate 1 to the other end thereof. The moving part 11 is disposed at the sliding rails 13, and is capable of moving on the sliding rails 13 along a cutting direction D horizontally.

In the embodiment, the moving part 11 is a roller, and the height of the sliding rails 13 is adjustable. Before the cutting process, the height of the sliding rails 13 is configured to align the cutting part 11 with a stripping start line P between the flexible substrate 1 and the release layer 3.

The attracting wheel 20 comprises a body part 21 and an adsorption part 22. The body part 21 is capable of rolling on the flexible substrate 1, and the adsorption part 22 is located on the body part 21 and is capable of generating an adsorption force. When the cutting part 12 cuts at least a part of the flexible substrate 1 from the release layer 3, the part of the flexible substrate 1 can be adsorbed and combined with the body part 21 by the adsorption force generated by the adsorption part 22, such that the flexible substrate 1 can be stripped from the release layer 3.

As shown in FIG. 3 and FIG. 4, openings located at the body part 21 act as the adsorption part 22. A plurality of vacuum pipes are disposed in the body part 21, and an end of each vacuum pipe 23 communicates with a shaft S of the body part 21, and the other end communicates with the opening to allow a vacuum pump (not shown) connected to the shaft S to vacuumize the inside part of the body part 21, thereby allowing the adsorption part 22 to generate adsorption force.

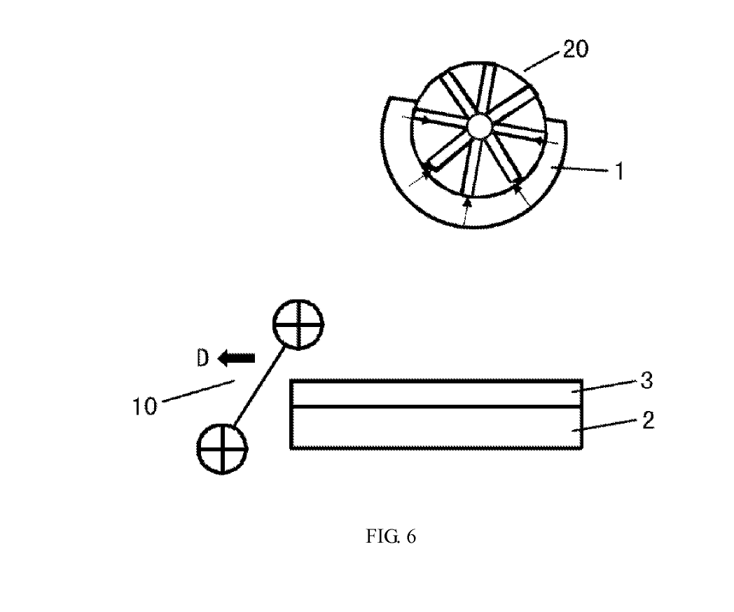

In the embodiment, the body part 21 is tubular, and the outer diameter of which is larger than or equal to the length of the flexible substrate 1, and for example larger than the length of the flexible substrate 1. As a result, when the attracting wheel 20 rolls from one end of the flexible substrate 1 to the other end, the whole flexible substrate 1 can be adsorbed at the periphery of the body part 21, as shown in FIG. 6.

The moving speed of the attracting wheel 20 is less than or equal to the moving speed of the wire cutter 10. For example, the moving speed of the attracting wheel 20 is less than the moving speed of the wire cutter 10, which means the flexible substrate 1 is adsorbed by the attracting wheel 20 after being cut out from the release layer 3 first. As a result, the flexible substrate 1 only bears an adsorption force when it is adsorbed without overcoming any adhesive force applied from the release layer 3, and as a result, it is easy to roll the flexible substrate 1 from the release layer 3, and it can prevent flexible substrate 1 from the break and even damage due to bearing opposite forces at upper and lower sides.

The stripping method for stripping the flexible substrate using the stripping device according to an embodiment of the disclosure is illustrated hereinbelow.

The stripping method includes the following step:

Step 1, as shown in FIG. 4, aligning the cutting part 12 with a stripping start line P between the flexible substrate 1 and the release layer 3, and disposing an attracting wheel 20 on the flexible substrate 1;

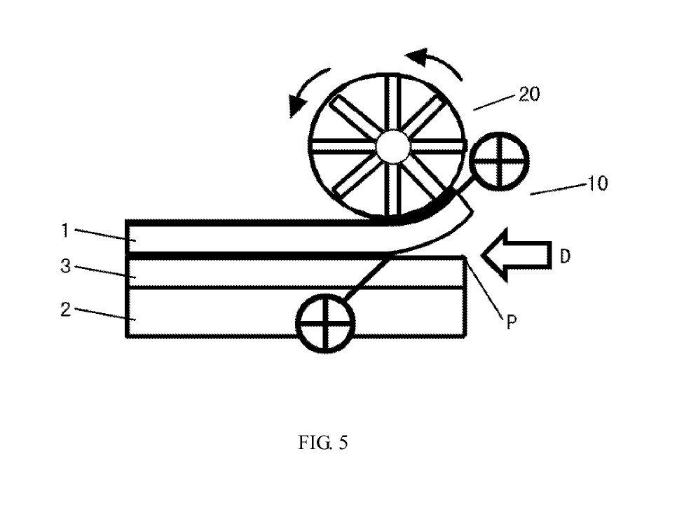

Step 2, as shown in FIG. 5, moving the cutting part 12 along the cutting direction D from the stripping start line P and cutting out the flexible substrate 1 from the release layer 3;

Step 3, generating an adsorption force to the flexible substrate 1 by the adsorption part 22 of the attracting wheel 20 contacting the flexible substrate 1, and adsorbing the cut flexible substrate 1 to the body part 21 of the attracting wheel 20. In the embodiment, a vacuum pump (not shown) is used to vacuumize the inner part of the body part 21, thereby making the adsorption part 22 generate the adsorption force. When the attracting wheel 20 moves to a cutting end point, the whole flexible substrate 1 is wrapped on the periphery of the body part 21, and is completely stripped from the release layer 3, as shown in FIG. 6. Afterwards, the stripped flexible substrate 1 may be disposed at a required position, and the vacuum pump is deflated to make the flexible substrate 1 come off the attracting wheel 20.

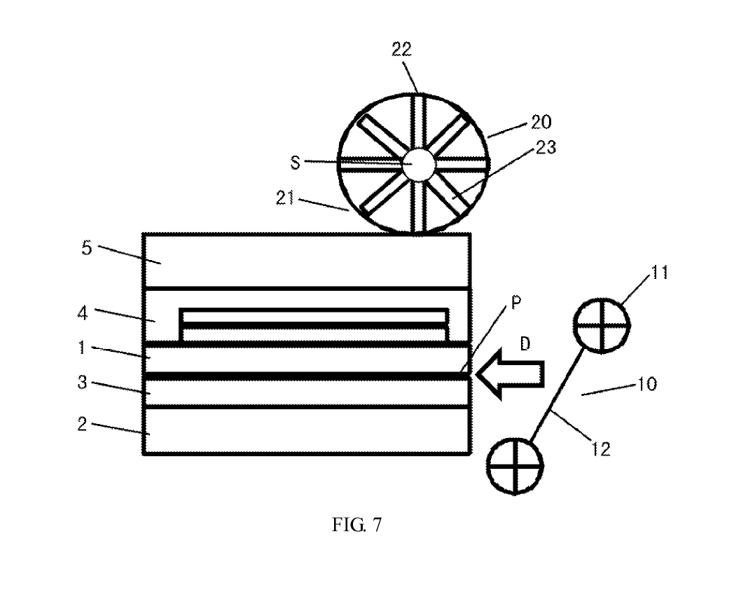

The embodiment of the disclosure only takes the case of stripping off the flexible substrate as an example, it should be understood that, the stripping device in the disclosure may be used to strip off multi-layer substrate from a layer stuck to it. As shown in FIG. 7, the multi-layer substrate comprises a flexible substrate 1, a TFT layer 4 and a flexible cover plate 5. The attracting wheel 2 is disposed at the top of the multi-layer substrate, namely the upper surface of the flexible cover plate 5, the cutting part 12 is positioned to be aligned with the stripping start line P between the flexible substrate 1 and the release layer 3, and then the stripping step in the disclosure is performed.

To sum up, the stripping device in the disclosure can separate the flexible substrate from the release layer fast and conveniently by means of cooperation between the linear cutting of the wire cutter and the rolling adsorption of the attracting wheel, it utilizes the attracting wheel to adsorb the stripped flexible substrate and dispose it to a required position, which is benefit for the subsequent processes. Compared with the conventional laser lift-up method, the stripping device and stripping method in the disclosure has high efficiency and low equipment cost.

Exemplary embodiments have been specifically shown and described as above. It will be appreciated by those skilled in the art that the disclosure is not limited the disclosed embodiments; rather, all suitable modifications and equivalent which come within the spirit and scope of the appended claims are intended to fall within the scope of the disclosure.

What is claimed is:

1. A stripping device for stripping a flexible substrate from a release layer, the stripping device comprising:
a wire cutter comprising a moving part and a cutting part connected to the moving part in such a manner that the moving part is able to drive the cutting part linearly; and
an attracting wheel comprising a body part adapted to be movably mounted on the flexible substrate so that the body part is able to roll on the flexible substrate and an adsorption part connected to the body part to generate adsorption force
to securely attach a part of the flexible substrate as the result of movement of the cutting part.

2. The stripping device according to claim 1, further comprising at least one sliding rail adapted to be formed on a side of the flexible substrate to partially accommodate the moving part so that the moving part is able to move horizontally on the at least one sliding-rail.

3. The stripping device according to claim 2, wherein the moving part is a roller.

4. The stripping device according to claim 2, wherein the at least one sliding rail is supported by a pair of adjustable rod for adjusting height of the at least one sliding rail.

5. The stripping device according to claim 4, wherein the height of the at least one sliding rail is adjusted by the adjustable rod to allow the cutting part to readily separate the flexible substrate and the release layer.

6. The stripping device according to claim 1, wherein the adsorption part comprises openings communicated with the body part.

7. The stripping device according to claim 6, further comprising a plurality of vacuum pipes and a vacuum pump, the vacuum pipes are disposed at an inside part of the body part, and an end of each vacuum pipe communicates with a shaft of the body part, and the other end communicates with the opening correspondingly, the vacuum pump is connected to the shaft so as to vacuumize the inside part of the body part to allow the adsorption part to generate adsorption force.

8. The stripping device according to claim 1, wherein the body part has a tubular shape with outer diameter larger than or equal to length of the flexible substrate.

9. The stripping device according to claim 1, wherein moving speed of the body part is less than or equal to moving speed of the moving part.

10. A stripping method for stripping a flexible substrate from a release layer, the method comprising the steps of:
aligning a cutting part with a stripping start line between a flexible substrate and a release layer, and disposing an attracting wheel on the flexible substrate;
moving the cutting part along a cutting direction from the stripping start line so as to cut out a part of the flexible substrate from the release layer; and
generating an adsorption force to a part of the flexible substrate through an adsorption part of the attracting wheel, and rolling a body part of the attracting wheel on the flexible substrate to so as to securely attach a part of the flexible substrate as the result of movement of the cutting part.

11. The stripping method according to claim 10, wherein moving speed of the body part is less than or equal to moving speed of the moving part.

12. The stripping method according to claim 10, wherein when the attracting wheel moves to a cutting end point along the cutting direction, the flexible substrate is entirely wrapped on a periphery of the body part and is completely stripped from the release layer.

13. The stripping method according to claim 10, wherein a vacuum pump is used to vacuumize an inside part of the body part to allow the adsorption part to generate the adsorption force.

14. The stripping method according to claim 13, further comprising a step of deflating the vacuum pump to disengage the stripped flexible substrate from the attracting wheel after the flexible substrate is completely stripped from the release layer.
